(19) United States
(12) Patent Application Publication
(10) Pub. No.: US 2008/0219479 A1
(43) Pub. Date: Sep. 11, 2008

(54) Audio Output Circuit and Audio Output Method

(75) Inventor: Sadao IBUKURO, Yokohama (JP)

Correspondence Address: ARENT FOX LLP, 1050 CONNECTICUT AVENUE, N.W., SUITE 400, WASHINGTON, DC, 20036, US

(73) Assignee: Fujitsu Limited, Kawasaki (JP)

(21) Appl. No.: 12/044,516

(22) Filed: Mar. 7, 2008

(30) Foreign Application Priority Data
Mar. 7, 2007 (JP) 2007-056590

(51) Int. Cl. H04R 25/00

(52) U.S. Cl. 381/120

(57) ABSTRACT

An audio output circuit including an input-signal generation block generating an input signal obtained by integrating a cyclic waveform and inputting the input signal to an audio amplifier at a transition from a normal operation to a power down state or at a return from the power down state to the normal operation, wherein an amplifier output terminal of the audio amplifier and an audio output unit are coupled via a capacitor.

### CROSS-REFERENCE TO RELATED APPLICATIONS

This application is based upon and claims the benefits of priority from the prior Japanese Patent Application No. 2007-056590, filed on Mar. 7, 2007, the entire contents of which are incorporated herein by reference.

### BACKGROUND

1. Field

The present embodiment relates to audio output circuits having an audio amplifier for use with mobile phones and portable musical devices and audio output methods.

2. Description of the Related Art

Audio amplifiers for use with mobile phones and portable musical devices are held in a power down state to reduce power consumption except when sound is being reproduced.

FIGS. 9A and 9B show schematic diagrams of conventional audio amplifiers.

The audio amplifier shown in FIG. 9A has an operational amplifier OP operating on a power supply voltage Vcc. The operational amplifier OP has a negative terminal connected to an XIN terminal through a resistor R1, a positive terminal connected to an IN terminal, and an OUT terminal connected to the negative terminal through a resistor R2 and also to an audio output unit SP such as a speaker and a headphone (or an earphone) through a capacitor C1.

In FIG. 9B, the audio output unit SP is replaced by a resistor Rsp. The resistor Rsp has usually a resistance of about 8 to 64 Ω. The capacitor C1 has usually a capacitance of around 100 μF to enhance low-frequency components. The operational amplifier OP will be described as an inverting amplifier having a gain of 1 (0 dB) for simplicity.

In such audio amplifiers, a signal ground potential Vsg (usually a voltage around Vcc/2) is applied to the open XIN terminal, and a voltage of Vsg/2 is applied to the open IN terminal, at a return from the power down state to the normal operation. This activates the operational amplifier OP. Then, a voltage waveform as described below is given to the IN terminal.

FIG. 10 shows voltage waveforms at a return from the power down state to the normal operation.

The vertical axis represents voltage V, and the horizontal axis represents time T. The signal ground potential Vsg is normalized to 1, and the time at which the potential of the OUT terminal reaches the signal ground potential Vsg is normalized to 1. In the figure, IN represents the waveform of a voltage input to the IN terminal, OUT represents the voltage waveform at the OUT terminal of the operational amplifier OP, and Vsp represents the waveform of a voltage Vsp applied to the audio output unit SP.

A waveform increasing toward the signal ground voltage Vsg is given to the IN terminal, where Vsg/2 is first applied. This increases the potential of the OUT terminal from a power supply ground potential (0 V) to the signal ground potential Vsg. The voltage Vsp across the audio output unit SP rises when the potential of the OUT terminal starts rising. The voltage Vsp increases to a certain level, and the level is maintained. The voltage Vsp decreases to 0 V when the potential of the OUT terminal reaches the voltage Vsp.

When the potential of the OUT terminal becomes the signal ground voltage Vsg, no current passes through the capacitor C1. At that time, a music signal voltage varying about the signal ground potential Vsg is input to the XIN terminal to reproduce the music. This is the normal operation.

During the normal operation, the potential of the OUT terminal of the operational amplifier OP varies around the signal ground potential Vsg, and the voltage Vsp applied to the audio output unit SP varies around the power supply ground potential.

At a return from the power down state to the normal operation, the following problem occurs.

FIG. 11 is a view showing the potential of the OUT terminal rising stepwise.

It is known that if a phase compensation capacitor (not shown), generally used with an operational amplifier OP, has a large capacitance, the output of the OUT terminal does not change until the capacitor loses the electric charge. After the electric charge is lost, the output rises stepwise, as shown in FIG. 11. For example, the potential of the IN terminal rising at a rate of 1 V/10 ms causes a stepped rising edge of several tens of millivolts to be generated. When this occurs, an unpleasant sound is produced from the speaker or headphone.

The unusual sound can be avoided by changing the rise of the potential of the IN terminal at a rate slower than or equal to the rate at which the capacitor loses the electric charge.

A conventional technology (such as that disclosed in Unexamined Japanese Patent Application Publication No. 2006-25246) makes the rise of the potential of the IN terminal smooth, so that no unusual sound is produced.

At a transition from the normal operation to the power down state, the music signal voltage that has been applied to the XIN terminal is switched to the signal ground potential Vsg, and a waveform, which will be described below, is given to the IN terminal.

FIG. 12 shows voltage waveforms at a transition to the power down state.

The vertical axis represents voltage V, and the horizontal axis represents time T. The signal ground potential Vsg is normalized to 1, and the time at which the voltage at the OUT terminal becomes zero is normalized to 1. In the figure, IN represents the voltage waveform input to the IN terminal, OUT represents the voltage waveform at the OUT terminal of the operational amplifier OP, and Vsp represents the waveform of the voltage Vsp applied to the audio output unit SP.

A voltage waveform smoothly changing from the signal ground potential Vsg to Vsg/2 is input to the IN terminal. This blocks vibrations in the audible range. The waveform is represented here by a straight line for simplicity. The input of this waveform to the IN terminal lowers the voltage at the OUT terminal of the operational amplifier OP from the signal ground voltage Vsg to the power supply ground voltage (0 V). If the operational amplifier OP is formed by a complementary metal-oxide semiconductor (CMOS) integrated circuit (IC), when it is brought into a low power mode by opening the XIN terminal and the IN terminal when the potential difference across the capacitor C1 disappears, the consumed current becomes about several nanoamperes. The period of this sequence generally ranges from several tens milliseconds to 100 milliseconds.

The voltage Vsp of the audio output unit SP has a rectangular waveform with low-range cutoff applied. The position of the diaphragm of the speaker or headphone is proportional to the voltage Vsp, so that the sound of the rectangular wave is output.

The conventional technologies, however, require troublesome adjustment of circuit parameters for increasing the potential of the input signal smoothly to such values that no unusual sound will be produced at a return from the power down state to the normal operation.

The rectangular wave described above is also generated at a transition from the normal operation to the power down state. Since the rectangular wave having a frequency of just 10 Hz contains a harmonic component having a high level, and the component is located in the human audible range (about 30 Hz to 15 kHz), an unusual sound is consequently produced.

### SUMMARY

It is an aspect of the embodiments discussed herein to provide an audio output circuit including an input-signal generation block generating an input signal obtained by integrating a cyclic waveform and inputting the input signal to an audio amplifier at a transition from a normal operation to a power down state or at a return from the power down state to the normal operation, wherein an amplifier output terminal of the audio amplifier and an audio output unit are coupled via a capacitor.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

FIG. 1 shows the structure of an audio output circuit of an embodiment.

FIG. 2 shows an example signal waveform (an integrated waveform of a sinusoidal wave) input to an amplifier at a return from the power down state to the normal operation.

FIG. 3 shows an example waveform of current flowing through an audio output unit at a return from the power down state to the normal operation.

FIG. 4 shows an example sinusoidal wave to be used at a transition from the normal operation to the power down state.

FIG. 5 shows an example waveform (an integrated waveform of a sinusoidal wave) of a signal input to the amplifier at a transition from the normal operation to the power down state.

FIG. 6 shows an example triangular wave.

FIG. 7 shows an example integrated waveform of a triangular wave.

FIG. 8 shows an example configuration of an input-signal generation block.

FIGS. 9A and 9B are schematic diagrams of conventional audio amplifiers.

FIG. 10 shows voltage waveforms at a return from the power down state to the normal operation.

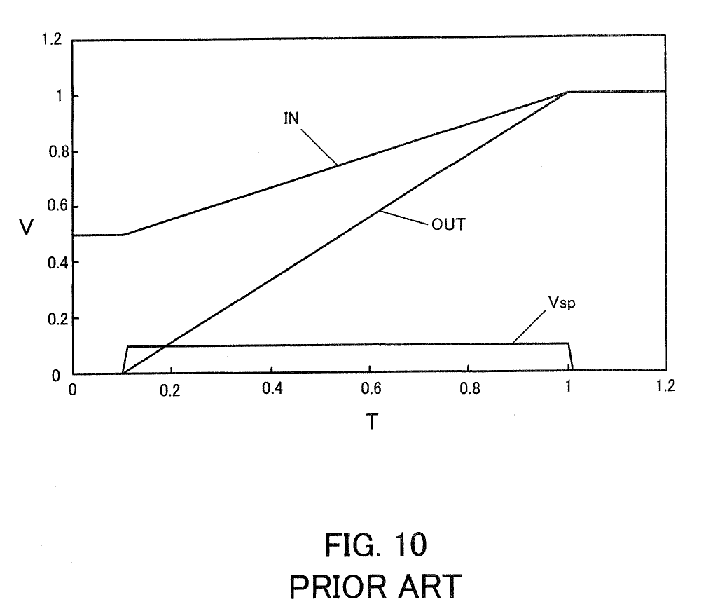

FIG. 11 shows the potential of an OUT terminal rising stepwise.

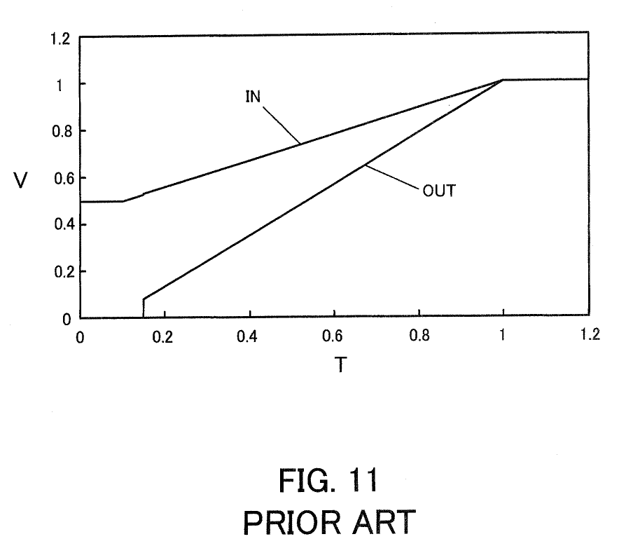

FIG. 12 shows voltage waveforms at a transition to the power down state.

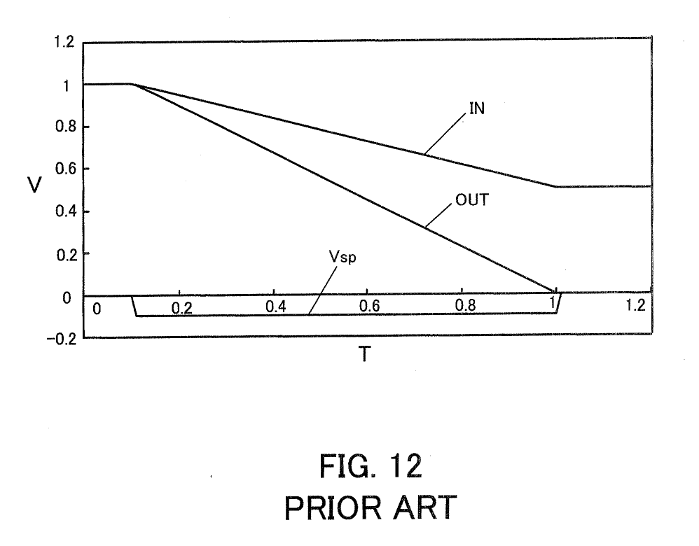

### DESCRIPTION OF THE PREFERRED EMBODIMENTS

An embodiment will be described below in detail with reference to the drawings.

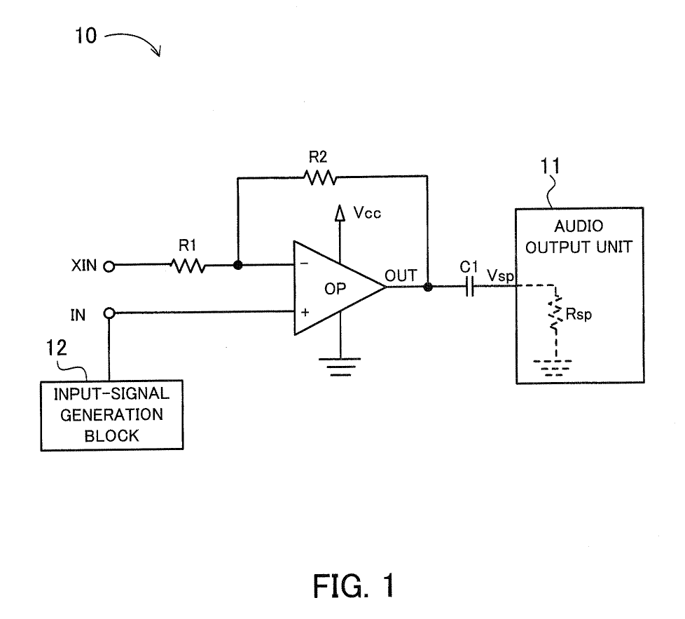

FIG. 1 shows the structure of an audio output circuit 10 of the embodiment.

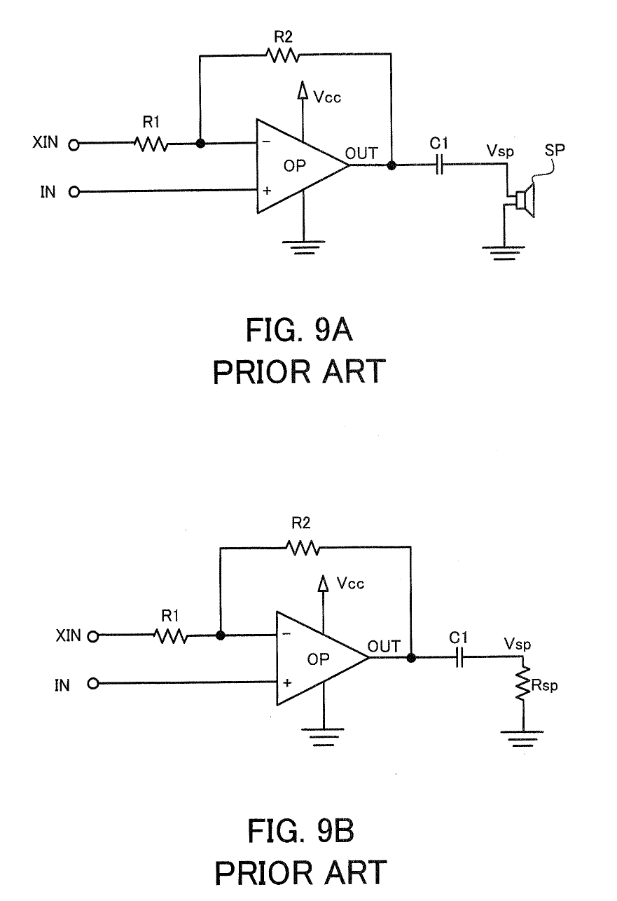

The audio output circuit 10 has an audio amplifier like that shown in FIG. 9. The audio amplifier has an operational amplifier OP operating on a power supply voltage Vcc. The operational amplifier OP has a negative terminal connected to an XIN terminal through a resistor R1, a positive terminal connected to an IN terminal, and an OUT terminal connected to the negative terminal through a resistor R2 and also to an audio output unit 11 such as a speaker and a headphone (or an earphone) through a capacitor C1.

The audio output unit 11 is represented by a resistor Rsp. The resistor Rsp here has usually a resistance of about 8 to 64 Ω. The capacitor C1 has a capacitance of about 10 μF to enhance low frequency components.

The audio output circuit 10 of the embodiment further includes an input-signal generation block 12.

The input-signal generation block 12 generates an integrated waveform of a cyclic wave such as a sinusoidal wave and a triangular wave and inputs the waveform to the IN terminal of the audio amplifier at a transition from the normal operation to the power down state or at a return from the power down state to the normal operation. The sinusoidal wave or triangular wave here has a frequency of 10 Hz, for instance, and the integrated waveform is input to the IN terminal.

The sinusoidal wave contains few harmonic components. The triangular wave does not contain many harmonic components. For instance, when a sinusoidal wave or triangular wave of 10 Hz is output from a speaker, the sound is hardly perceived. On the contrary, a rectangular wave of 10 Hz contains harmonic components within the human audible range (about 30 Hz to 15 kHz), and the sound can be clearly recognized.

The operation of the audio output circuit 10 of the embodiment will be described below.

The operational amplifier OP will be described as an inverting amplifier having a gain of 1 (0 dB).

At a return from the power down state to the normal operation, the potential of the XIN terminal is fixed to Vcc/2. This is controlled by a control circuit (not shown) for controlling each block in accordance with any state change to or from the power down state or the normal operation, for instance.

The input-signal generation block 12 inputs an input signal obtained by integrating a sinusoidal wave or a triangular wave, for instance, to the IN terminal. Use of the sinusoidal wave will be described first.

y1=(½)+(½)sin(x−π/2) 0<x<2π (1)

If a sinusoidal wave y1 can be expressed by the equation (1), its integrated waveform y2 can be expressed as follows:

y2=(x/2)−(½)cos(x×π/2) (2)

A graph representing the equation (2), with y2 taken as voltage V and x taken as time T on the normalized time axis and amplitude, will be described below.

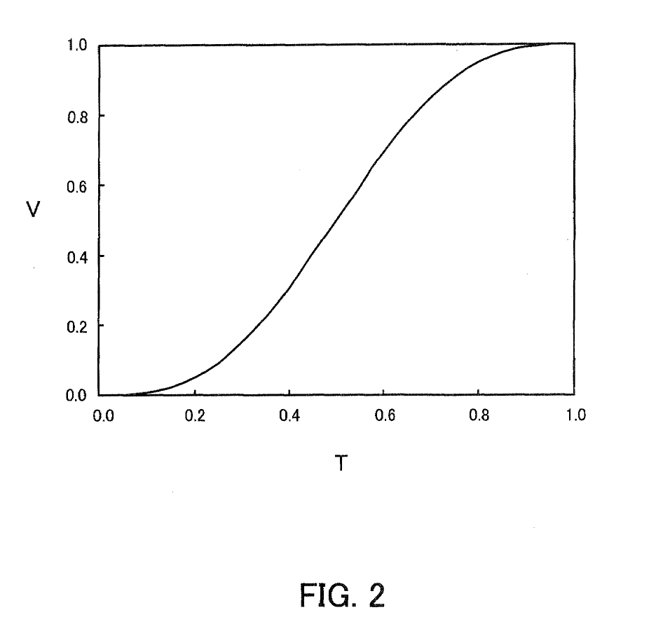

FIG. 2 shows an example signal waveform (an integrated waveform of a sinusoidal wave) input to the audio amplifier at a return from the power down state to the normal operation.

At the return from the power down state to the normal operation, the input-signal generation block 12 inputs a waveform such as that shown in FIG. 2, with “0” converted to Vcc/4 and “1” converted to Vcc/2 in amplitude, to the IN terminal. Consequently, the OUT terminal of the operational amplifier OP outputs the waveform shown in FIG. 2, with “0” converted to 0 V and “1” converted to Vcc/2 (signal ground potential Vsg) in amplitude.

Because the waveform input to the IN terminal has a very slow rising edge, as shown in FIG. 2, the potential of the OUT terminal of the operational amplifier OP will not have a stepped rising edge.

Since the signal output from the OUT terminal is differentiated by a differentiating circuit formed by the capacitor C1 and the resistor Rsp, the waveform of current flowing through the audio output unit 11 is expressed by the equation (1). A graph representing the equation (1), with y2 taken as current I and x taken as time T on the normalized time axis and amplitude, will be described below.

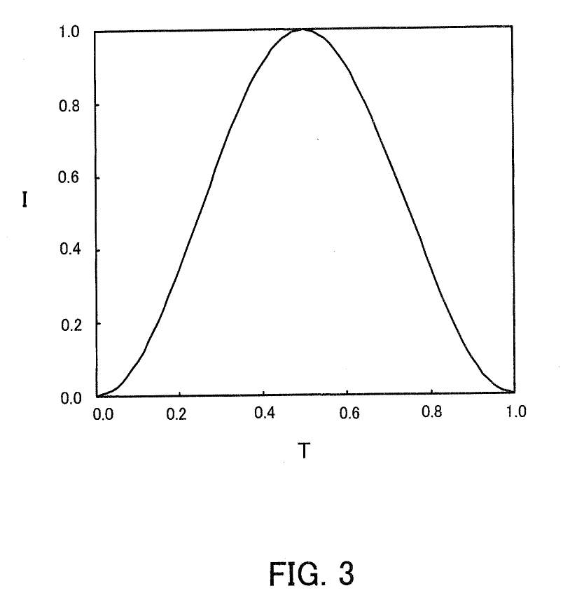

FIG. 3 shows an example waveform of current flowing through the audio output unit at a return from the power down state to the normal operation.

Sinusoidal waves like that shown in the figure hardly contain harmonics, and an unusual sound in the human audible range will not be generated.

In the normal operation, when the potential of the OUT terminal reaches the signal ground potential Vsg and when no current flows through the capacitor C1, a music signal voltage varying around the signal ground potential Vsg is input to the XIN terminal to reproduce the music. The potential of the OUT terminal of the operational amplifier OP varies around the signal ground potential Vsg, and the voltage Vsp applied to the audio output unit 11 varies about the power supply ground potential (0 V).

The operation at a transition from the normal operation to the power down state will be described next.

The XIN terminal is fixed to Vcc/2, and the input-signal generation block 12 generates an integrated waveform of a sinusoidal wave as described below and inputs the waveform to the IN terminal.

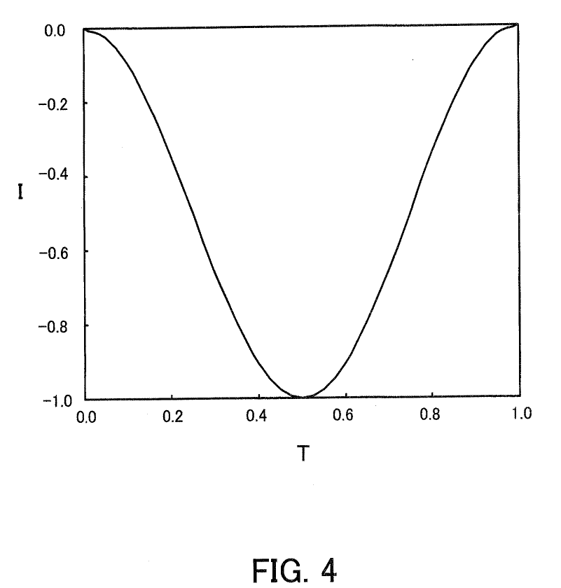

FIG. 4 shows an example sinusoidal wave to be used at a transition from the normal operation to the power down state.

The wave swings in a negative current zone, on the contrary to the sinusoidal wave shown in FIG. 3. The vertical axis represents normalized current I, and the horizontal axis represents normalized time T.

The integrated waveform of the sinusoidal wave will be described below.

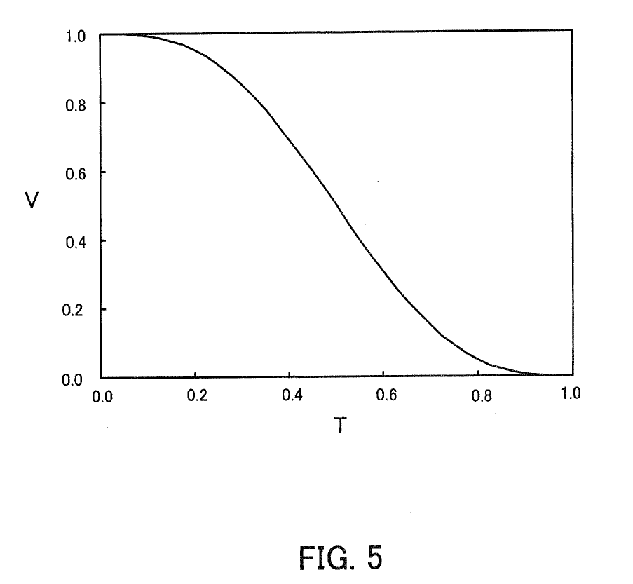

FIG. 5 shows an example waveform (an integrated waveform of a sinusoidal wave) of a signal input to the audio amplifier at a transition from the normal operation to the power down state.

The integrated waveform of the sinusoidal wave shown in FIG. 4 shows that the amplitude decreases from 1 to 0, on the contrary to the waveform shown in FIG. 2. The vertical axis represents normalized voltage V, and the horizontal axis represents normalized time T.

The input-signal generation block 12 inputs a waveform such as that shown in FIG. 5, with “0” converted to Vcc/4 and “1” converted to Vcc/2 in amplitude, to the IN terminal. This causes the OUT terminal of the operational amplifier OP to output the waveform shown in FIG. 5, with “0” converted to 0 V and “1” converted to Vcc/2 in amplitude.

The signal output from the OUT terminal is differentiated by the differentiating circuit, formed by the capacitor C1 and the resistor Rsp, and flows through the audio output unit 11, and the waveform of the current becomes a sinusoidal wave as shown in FIG. 4.

By passing the current having a sinusoidal wave hardly containing harmonics through the audio output unit 11, an unusual sound in the human audible range can be avoided at a transition from the normal operation to the power down state.

Use of a triangular wave instead of the sinusoidal wave will be described next.

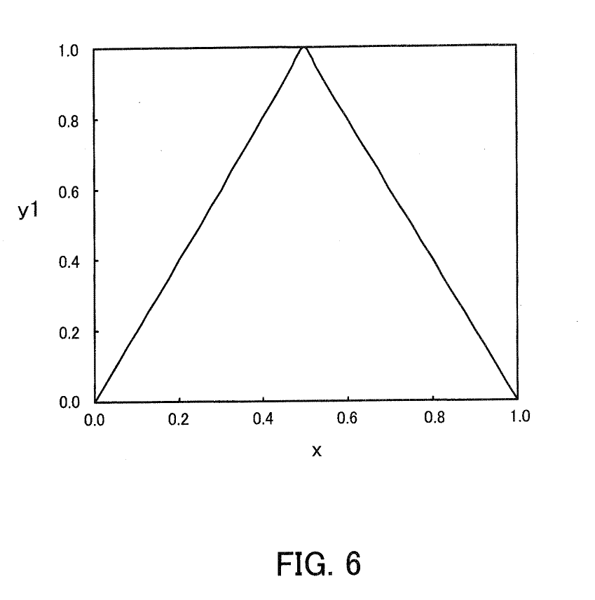

FIG. 6 shows an example triangular wave.

The triangular wave can be expressed by the following equations.

0<x<0.5 y1=2x (3)

0.5<x<1 y1=2−2x (4)

An integrated waveform of the triangular wave will be described below.

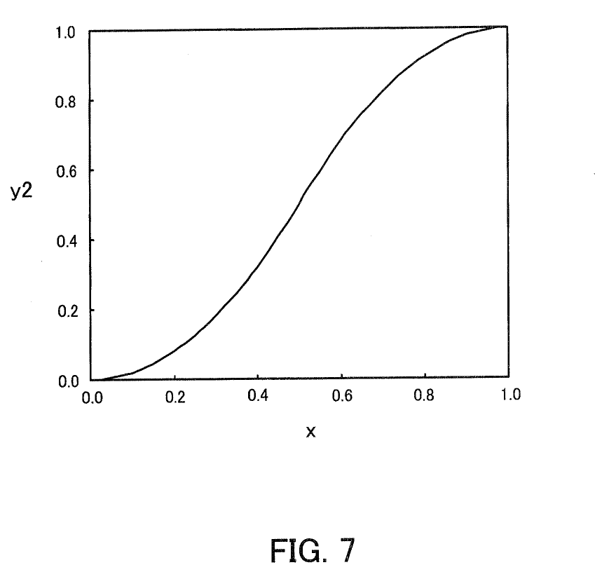

FIG. 7 shows an example integrated waveform of the triangular wave.

The integrated waveform of the triangular wave can be expressed by the following equations.

0<x<0.5 y2=x² (5)

0.5<x<1 y2=−0.5+2x−x² (6)

At a return from the power down state to the normal operation, the input-signal generation block 12 generates an integrated waveform of a triangular wave such as that shown in FIG. 7, converts “0” to Vcc/4 and “1” to Vcc/2 in amplitude, and inputs the waveform to the IN terminal. This causes the OUT terminal of the operational amplifier OP to output the waveform shown in FIG. 7, with “0” converted to 0 V and “1” converted to Vcc/2 in amplitude. Like the waveform shown in FIG. 2, the waveform shown in FIG. 7 has a very slow rising edge, and a stepped rising edge will not be generated in the potential of the OUT terminal of the operational amplifier OP.

When a waveform such as that shown in FIG. 7 is input to the IN terminal, the waveform of current flowing through the audio output unit 11 becomes a triangular wave, such as that shown in FIG. 6. Like the sinusoidal wave, the triangular wave does not contain many harmonics, so that an unusual sound will not be produced.

At a transition from the normal operation to the power down state, the input-signal generation block 12 inputs an integrated waveform of a triangular wave like an inversion of the waveform shown in FIG. 6, that is, a triangular wave swinging in a negative current zone, to the IN terminal, with “0” converted to Vcc/4 and “1” converted to Vcc/2 in amplitude. Then, the waveform of current flowing through the audio output unit 11 becomes a triangular wave like an inversion of the waveform shown in FIG. 6, and an unusual sound in the human audible range can be avoided.

The input-signal generation block 12 will be described below in detail.

The input-signal generation block 12 generates an integrated waveform of a sinusoidal wave or a triangular wave and inputs the waveform to the IN terminal, as has been described above. A digital/analog (D/A) converter may be used to obtain the integrated waveform. For instance, data written in a read-only memory (ROM) may be input to the D/A converter to generate a waveform satisfying the equation (2) or the equations (5) and (6).

Because the D/A converter is a large circuit, a small analog circuit may be desired instead. An example specific circuit configuration of the input-signal generation block 12 for generating an integrated waveform of a triangular wave will next be described.

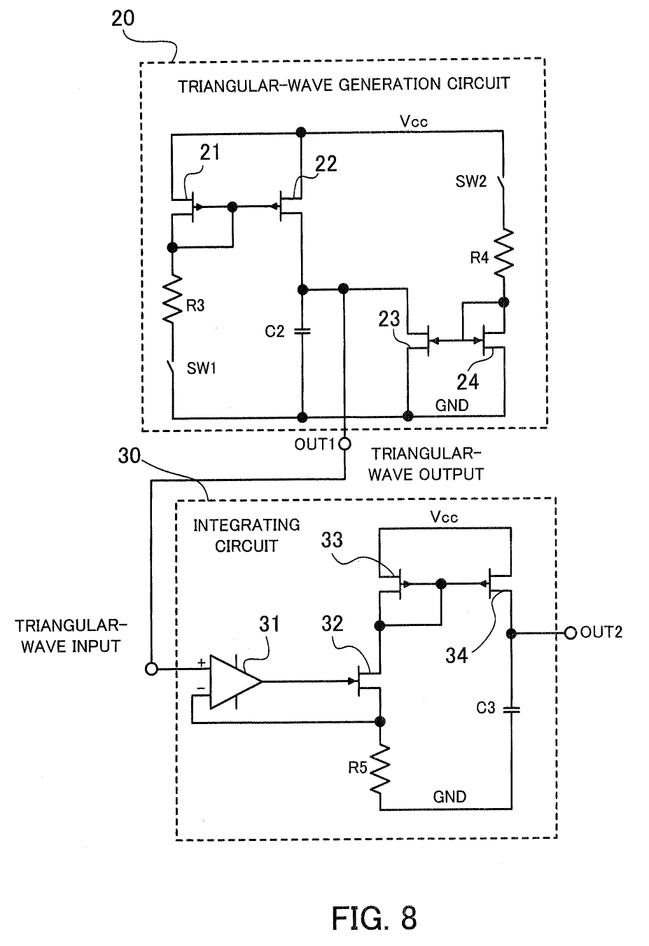

FIG. 8 shows an example circuit of the input-signal generation block 12.

The input-signal generation block 12 includes a triangular-wave generation circuit 20 and an integrating circuit 30.

The triangular-wave generation circuit 20 includes p-channel metallic oxide semiconductor field effect transistors (MOSFETs) (hereinafter called pMOSs) 21 and 22, n-channel MOSFETs (hereinafter called nMOSs) 23 and 24, resistors R3 and R4, a capacitor C2, and switches SW1 and SW2.

The power supply voltage Vcc is applied to the sources of the pMOSs 21 and 22, and the gates are connected to each other and also to the drain of the pMOS 21. The drain of the PMOS 21 is also connected to the ground potential line (GND) through the resistor R3 and the switch SW1. The drain of the PMOS 22 is connected to GND through the capacitor C2 and also to an OUT1 terminal and the drain of the nMOS 23. The nMOSs 23 and 24 have their sources connected to GND and their gates connected to each other and also to the drain of the nMOS 24. The power supply voltage Vcc is applied to the drain of the NMOS 24 through the resistor R4 and the switch SW2.

The switches SW1 and SW2 are opened and closed as controlled by a control circuit, which is not shown in the figure. The control circuit is a processor in a mobile phone or a portable musical device containing the audio output circuit 10 of the embodiment, for instance.

In the triangular-wave generation circuit 20 described above, when the voltage across the capacitor C2 is brought to 0 V and when the switch SW2 is opened and the switch SW1 is closed, a certain amount of current flows into the capacitor C2, increasing the potential of the OUT1 terminal linearly with respect to time. When the voltage reaches a certain level, the switch SW is opened and the witch SW2 is closed. Then, current is drawn from the capacitor C2, decreasing the potential of the OUT1 terminal linearly with respect to time. The potential rising rate and the potential falling rate can be specified as desired by selecting the resistance of the resistors R3 and R4 and the capacitance of the capacitor C2.

The triangular wave generated as described above by the triangular-wave generation circuit 20 is input to the integrating circuit 30.

The integrating circuit 30 includes an amplifier 31, an nMOS 32, a pMOSs 33 and 34, a resistor R5, and a capacitor C3.

The triangular wave is input to the positive terminal of the amplifier 31, and the output terminal is connected to the gate of the RLMOS 32. The negative terminal of the amplifier 31 is connected to the source of the nMOS 32. The source of the NMOS 32 is also connected to GND through the resistor R5. The drain of the nMOS 32 is connected to the gates of the pMOSs 33 and 34 and the drain of the pMOS 33. The power supply voltage Vcc is applied to the sources of the pMOSs 33 and 34. The drain of the PMOS 34 is connected to an OUT2 terminal and also to GND through the capacitor C3.

In the integrating circuit 30 described above, when the triangular wave is input to the positive terminal of the amplifier 31, current proportional to the input voltage of the amplifier 31 flows through the nMOS 32 and the pMOSs 33 and 34. This current charges the capacitor C3, and the OUT2 terminal outputs an integrated waveform of the triangular wave.

The input-signal generation block 12 for outputting an integrated waveform of a triangular wave has been described above. An integrated waveform of a sinusoidal wave can be generated in the same way by a combination of a sinusoidal-wave generation circuit and its integrating circuit.

The audio output circuit 10 of the embodiment can prevent an unusual sound in the human audible range from being produced by a speaker or a headphone, just by inputting an integrated waveform of a sinusoidal wave or a triangular wave to the audio amplifier at a return from the power down state to the normal operation or at a transition from the normal operation to the power down state.

It has been described above that current of a sinusoidal wave or a triangular wave flows through the audio output unit 11. The waveform, however, should not always be an accurate sinusoidal or triangular wave and could be a cyclic waveform having a generally sinusoidal or triangular shape.

According to the present embodiment, an integrated waveform of a cyclic wave input to the audio amplifier has a very slow rising edge, so that a stepped rising edge will not be generated in the signal output from the amplifier output terminal at a return from the power down state to the normal operation.

The waveform of current flowing through the audio output unit is a cyclic waveform with few harmonics, so that an unusual sound will not be produced at a transition from the normal operation to the power down state.

The foregoing is considered as illustrative only of the principles of the present invention. Further, since numerous modifications and changes will readily occur to those skilled in the art, it is not desired to limit the invention to the exact construction and applications shown and described, and accordingly, all suitable modifications and equivalents may be regarded as falling within the scope of the invention in the appended claims and their equivalents.

What is claimed is:

1. An audio output circuit comprising:
an input-signal generation block generating an input signal obtained by integrating a cyclic waveform and inputting the input signal to an audio amplifier at a transition from a normal operation to a power down state or at a return from the power down state to the normal operation,
wherein an amplifier output terminal of the audio amplifier and an audio output unit are coupled via a capacitor.

2. The audio output circuit according to claim 1, wherein the cyclic waveform has a frequency outside a human audible range.

3. The audio output circuit according to claim 1, wherein the input-signal generation block comprises:
a cyclic-waveform generation circuit for generating the cyclic waveform; and
an integrating circuit for integrating the generated cyclic waveform.

4. The audio output circuit according to claim 1, wherein the cyclic waveform is a generally sinusoidal wave.

5. The audio output circuit according to claim 1, wherein the cyclic waveform is a generally triangular wave.

6. An audio output method comprising the steps of:
generating an input signal by integrating a cyclic waveform and inputting the input signal to an audio amplifier by means of an input-signal generation block at a transition from a normal operation to a power down state or at a return from the power down state to the normal operation; and
inputting a signal obtained by differentiating an output signal of an amplifier output terminal of the audio amplifier to an audio output unit by means of a differentiating circuit.

7. The audio output method according to claim 6, wherein the cyclic waveform has a frequency outside a human audible range.

8. The audio output method according to claim 6, wherein the input-signal generation block generates the cyclic waveform by means of a cyclic-waveform generation circuit and generates the input signal by integrating the cyclic waveform by means of an integrating circuit.

9. The audio output method according to claim 6, wherein the cyclic waveform is a generally sinusoidal wave.

10. The audio output method according to claim 6, wherein the cyclic waveform is a generally triangular wave.
